(19) United States
(12) Patent Application Publication
(10) Pub. No.: US 2024/0425025 A1
(43) Pub. Date: Dec. 26, 2024

(54) INTERLOCKING BELLCRANK DEVICE AND ASSOCIATED SYSTEMS AND METHODS

(71) Applicant: AYRO, Inc., Round Rock, TX (US)

(72) Inventor: Matthew Quinn, Austin, TX (US)

(21) Appl. No.: 18/339,417

(22) Filed: Jun. 22, 2023

(51) Int. Cl. F16H 51/02

(52) U.S. Cl. CPC B60T 11/04; B60T 7/04; F16D 65/16; F16D 2125/26

(57) ABSTRACT

An apparatus, system, and method according to which a bellcrank is used to transfer an output of a lever to a component requiring actuation. For example, a bellcrank that includes two interlocking portions transfers an output of a linear motion around a fixed axis via a rotational motion then to a transverse motion in order to pressurize brake fluid in a master cylinder of a vehicle.

### CROSS-REFERENCE TO RELATED APPLICATION

This application is related to U.S. patent application Ser. No. ______, Attorney Docket No. 58929.68US01, filed even date hereof, entitled “INTERLOCKING BELLCRANK DEVICE AND ASSOCIATED SYSTEMS AND METHODS,” the entire disclosure of which is hereby incorporated herein by reference.

### FIELD OF THE INVENTION

The field of the invention is technologies associated with a bellcrank device, and in particular, an interlocking and interchangeable bellcrank device for transferring an output of a linear motion around a fixed axis via a rotational motion then to a transverse motion to pressurize brake fluid in a master cylinder.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

A master cylinder is a component of a braking system of a vehicle that drives pressure generated by the brake pedal to the braking mechanism at the vehicle's wheels. In conventional systems, when a driver presses on the brake pedal a pushrod is pressed into a primary piston of the master cylinder, via a linear motion, in order to compress the brake fluid. As the primary piston is pushed, hydraulic pressure builds inside both the cylinder and the brake lines coupled to the cylinder. This pressure causes the secondary piston to compress the brake fluid, and consequentially, to engage the braking mechanism.

Because conventional master cylinders operate using only linear motion (i.e., driver pushes brake pedal and pushrod is inserted into a primary piston of the master cylinder), these conventional systems require a significant amount of space between the bulkhead and firewall of the vehicle to fit the master cylinder. In a non-cabover design, the master cylinder protrudes into the engine bay, which is in front of the firewall, so there is usually plenty of room to fit the master cylinders.

Low-speed vehicles (LSVs), which typically include four-wheel electric vehicles, have a top speed of about 25 to 35 miles per hour (about 40 to 56 kilometers per hour). These vehicles may be designed with a cabover design, which renders less space for components between the bulkhead and the firewall. Therefore, a conventional master cylinder is unable to be installed in a LSV in its traditional manner.

Therefore, there remains a need to develop a device to transform the motion transversely such that the master cylinder could be installed to fit in a vehicle with less space between the bulkhead and firewall and/or a vehicle with a cabover design such as an LSV. Additionally, there remains a need to develop a device that allows for various configurations depending on the required transverse motion.

### SUMMARY

In one example embodiment, a method is provided. An interlocking bellcrank in a first configuration is provided. A transverse motion requirement is received. Based on the transverse motion requirement, a second configuration is determined. The bellcrank is configured according to the second configuration. The interlocking bellcrank is provided in the second configuration.

In another example embodiment, a bellcrank system is provided. The bellcrank system includes a bellcrank that include a first portion including a first top surface and a first bottom surface. The first bottom surface opposes the first top surface. The first bottom surface includes a first set of indentations and a first set of extended portions. The first set of indentations and the first set of extended portions are disposed along a circumference of the first bottom surface. The bellcrank also includes a second portion that includes a second top surface and a second bottom surface. The second bottom surface opposes the second top surface. The second bottom surface includes a second set of indentations and a second set of extended portions. The second portion is disposed directly below the first portion such that: the first set of indentations is configured to interlock with the second set of extended portions; the second set of indentations is configured to interlock with the first set of extended portions; and the first bottom surface is in direct contact with the second top surface; and the bellcrank includes at least a first configuration and a second configuration.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 illustrates an example electric vehicle according to some embodiments.

FIG. 2A illustrates a front view of a portion of the example electric vehicle according to some embodiments.

FIG. 2B illustrates a back view of a portion of the example electric vehicle according to some embodiments.

FIG. 3 illustrates an example front elevational view of a bellcrank according to some embodiments.

FIG. 4 provides an example back elevational view of the bellcrank of FIG. 3 according to some embodiments.

FIG. 5 provides an example right elevational view of the bellcrank of FIG. 3 according to some embodiments.

FIG. 6 provides an example left elevational view of the bellcrank of FIG. 3 according to some embodiments.

FIG. 7 provides an example top plan view of the bellcrank of FIG. 3 according to some embodiments.

FIG. 8 provides an example bottom plan view of the bellcrank of FIG. 3 according to some embodiments.

FIG. 9 provides an example perspective view of the bellcrank of FIG. 3 according to some embodiments.

FIG. 10 provides another example perspective view of the bellcrank of FIG. 3 according to some embodiments.

FIG. 11 provides an example exploded-perspective view of the bellcrank of FIG. 3 according to some embodiments.

FIG. 12 provides another example exploded-perspective view of the bellcrank of FIG. 3 according to some embodiments.

FIG. 13 is a flowchart of an example method for changing a first configuration of the bellcrank to a second configuration according to some embodiments.

FIG. 14 is a flowchart of an example method for pressurizing brake according to some embodiments.

### DETAILED DESCRIPTION

Illustrative embodiments and related methods of the present disclosure are described below as they might be employed in one or more methods and systems for an interlocking bellcrank device. In the interest of clarity, not all features of an actual implementation or method are described in this specification. It will of course be appreciated that in the development of any such actual embodiment, numerous implementation specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure. Further aspects and advantages of the various embodiments and related methods of the disclosure will become apparent from consideration of the following description and drawings.

The example embodiments described below recognize that it may be desirable to have an interlocking bellcrank device that has various configurations depending on the required transverse motion. Additionally, the example embodiments describe below recognize, an example use of the interlocking bellcrank device-use in a master cylinder of a vehicle. For example, the use of the interlocking bellcrank device is space efficient. This allows for the master cylinder to be installed at a ninety-degree angle to fit in a vehicle with less space between the bulkhead and firewall and/or a vehicle with a cabover design such as a low-speed vehicle (LSV).

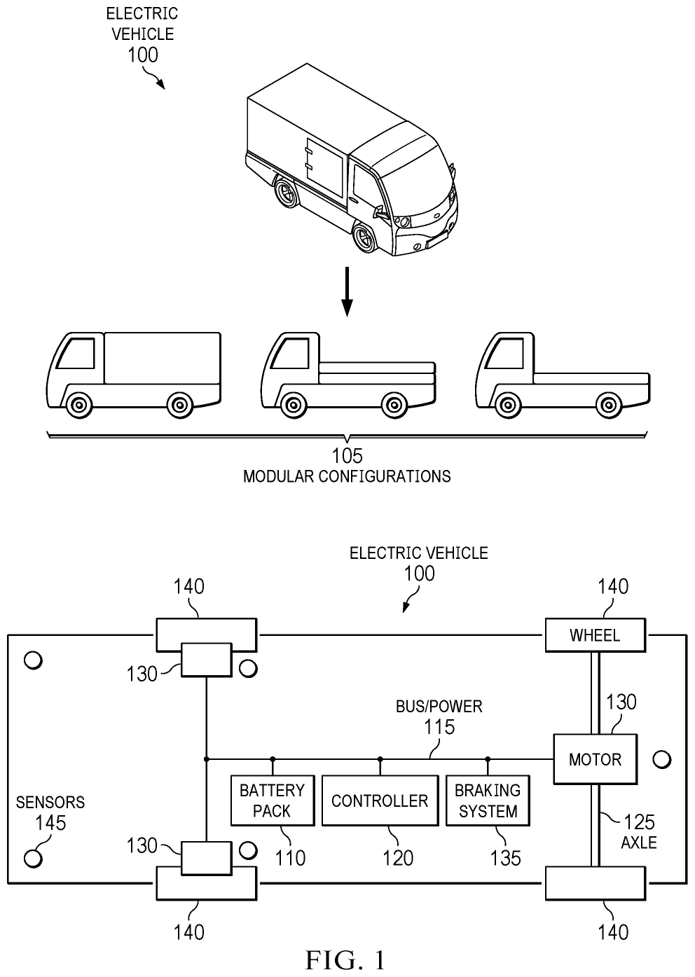

Referring to FIG. 1, in an embodiment, low-speed vehicle (LSV) is generally referred to by reference number 100 and includes one or more module configurations 105 permitting LSV 100 to change its target purpose. The LSV 100 also includes a battery pack 110, bus/power 115, and a controller 120 operationally coupled to the battery pack 110. The LSV 100 includes axles 125 to which one or more controllable motors 130, braking system 135, and controllable wheels 140 are each operationally coupled to. The controllable wheels 140 are mechanically coupled with at least one controllable motor 130, which in turn is electrically coupled with battery pack 110. The LSV includes a set of sensors 145, as represented by the small circles in FIG. 1, which are operationally coupled to and/or in communication with the controller 120.

In some embodiments, module configurations 105 may be considered to change the nature of LSV 100, which in turn can change which operational profiles are of most relevance, possibly based on the attributes of LSV 100. For example, in a flatbed configuration LSV 100 could be operating as a ground keeping vehicle. In which case, LSV 100 may be permitted to operate in natural terrains, lawns, fairways, forest, or other natural terrains for example. However, in a cargo configuration, LSV 100 could be operating in a delivery capacity. In which case, the corresponding operational profiles may permit LSV 100 to operate at higher speeds, but only on paved surfaces. Further, the various module configurations 105, as well as any loading/unloading of the LSV 100 (e.g., loading/unloading groundskeeping equipment, boxes, packages, etc.), may also change the center of gravity of the LSV 100, which in turn can change the operational profile.

In some embodiments, LSV 100 operates as a battery-powered electric vehicle. LSV 100 comprises at least one battery as represented by the battery pack 110. Battery pack 110 may comprise one or more rechargeable batteries (e.g., Li-ion, Li-polymer, Li—S, etc.). Further, in some embodiments, battery pack 110 may comprise one or more swappable batteries to facilitate getting the LSV 100 back in operation after a battery has drained. In some embodiments, the battery pack 110 is located near the rear of the vehicle. In other embodiments, the battery pack is located at least in part between the axles 125.

In some embodiments, the Bus/Power 115 interconnect the battery pack 110, the controller 120, the braking system 135, the motors 130, and/or the wheels 140.

In some embodiments, the controller 120 may control the brake response for the electric motor-generator, for example while in the second mode of operation, to achieve between about 60-70% energy regeneration by the regenerative braking force. In some embodiments, the controller 120 is referred to as a vehicular controller.

In one or more embodiments, the axles 125 includes a front axle and a back axle.

In some embodiments, LSV 100 presents various configurations of the controllable motors 130 for discussion purposes. In some examples, the motors 130 themselves may comprise an electric motor-generator that provides a motive rotational force in a first mode of operation, and charges (e.g., supplying electric energy to) the battery pack 110 by regenerative braking in a second mode of operation. In one or more embodiments, each of the controllable wheels 140 could have a dedicated motor 130 (e.g., such as an electric hub motor disposed within the wheels 140) in a manner that permits each wheel 140 to operate individually, but also collectively under instructions of the controller 120. Still, in other embodiments, a single motor 130 could couple to more than one wheel 140. For example, a single motor 130 could couple to the axle 125 of the LSV supporting two or more wheels where motor 130 causes wheels 140 to rotate via a drive train. In a further example, a single motor 130 could couple to two or more axles (such as axles 125) of the LSV, each of the two or more axles supporting two or more wheels, and where the motor 130 causes the wheels 140 to rotate via a drive train. Thus, it should be appreciated that the controllable wheels 140 rotate in response to engagement of one or more of motors 130.

In one or more embodiments, the braking system 135 may include a frictional, electromagnetic, and/or hydraulic braking system. In some embodiments, the braking system 135 includes one or more of a brake pedal, a master cylinder, brake fluid, brake lines, disc brakes, drum brakes, a brake light, a pressure switch, a pedal position sensor, and the like. In some embodiments, the braking system 135 may include a friction braking system such as an electrohydraulic or electromechanical braking system, an eddy current braking system, or other type of supplemental braking system that is coupled with the controller 120 and to one or more of the wheels 140, and which may be used separately from or in conjunction with the regenerative braking of the electric motor-generator(s). LSV 100 further comprises one or more controllers 120, which provide instructions to motors 130 or wheels 140 as well as governs other systems and/or operational parameters of LSV 100.

In some embodiments, the set of sensors 145 are located in a different configuration on LSV 100 than Shown in FIG. 1. In other embodiments, LSV 100 includes a different number of the set of sensors 145 from the set of sensors 145 shown in FIG. 1. While the set of sensors 145 are illustrated disposed on or about LSV 100, the inventive subject matter is not so restricted. Rather, the set of sensors 145 could be deployed remotely. Further sensor data could be obtained from any local or remote source (e.g., weather prediction, news events, etc.). The set of sensors 145 may include at least one location sensor; a GPS unit, for example. Still other types of location sensors could comprise image-based sensors, IMUs, wireless triangulation units, cellular network location units, or other types of location sensors. In other examples, the set of sensors 145 may include other sensors such as accelerometers, gyroscopes, piezoelectric sensors, cameras, LIDAR, radar, sound detectors, electromagnetic field sensors, wheel speed sensors, steering angle sensors, load sensors, displacement transducers, strain gauges (e.g., on the vehicle's suspension), or other types of sensors. In some embodiments, a set of sensors 145 are located on a portion of the braking system 135. In some embodiments, the set of sensors 145 includes a pedal position sensor, a pedal position range sensor, a pressure switch, a pressure sensor, and the like.

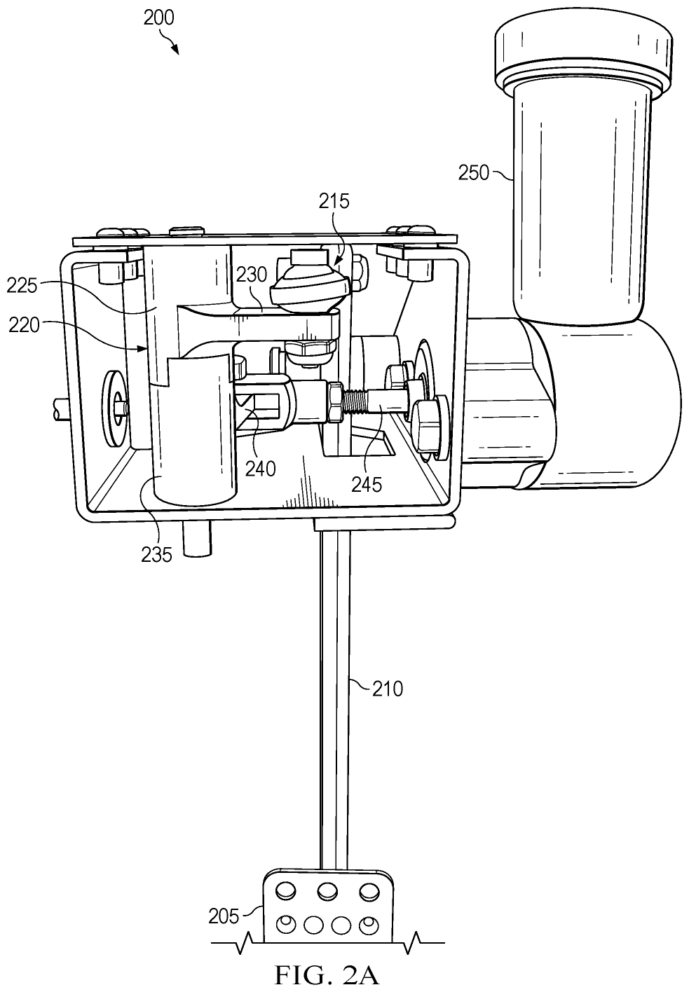

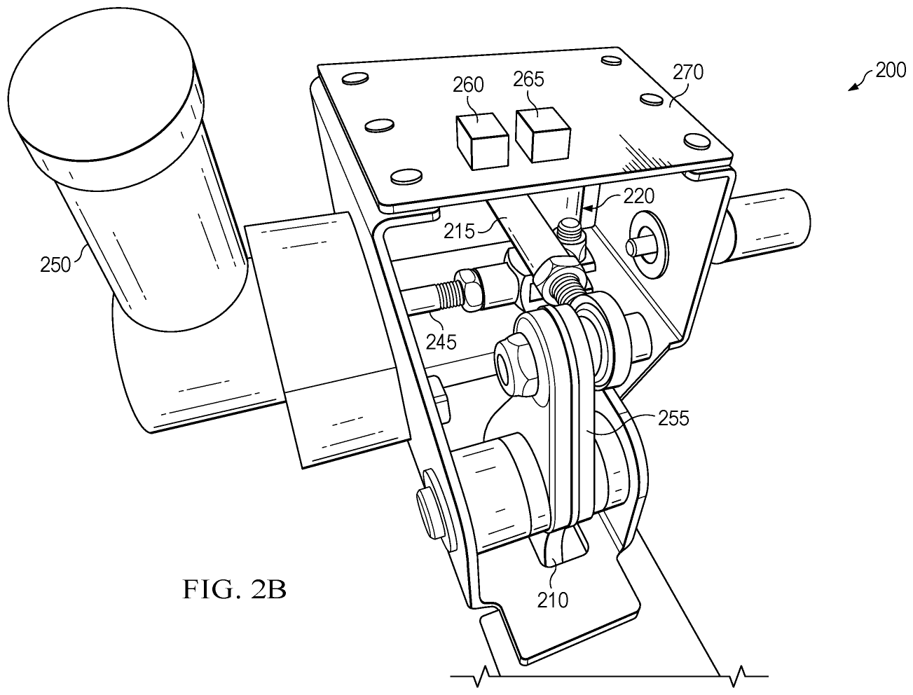

Referring to FIG. 2A, in an embodiment, FIG. 2A illustrates a front side of a braking system, the braking system is generally referred to by reference numeral 200. The braking system 200 includes: a brake pedal 205 that is operationally coupled to a lever 210, the lever 210 is operationally coupled to a first arm 215 and the first arm 215 is operationally coupled to an interlocking bellcrank 220. The interlocking bellcrank 220 includes a first portion of the interlocking bellcrank 225, and the first portion 225 includes a wing of the first portion 230. In particular, the first arm 215 is coupled to the wing of the first portion 230. The interlocking bellcrank 220 also includes a second portion of the interlocking bellcrank 235, and the second portion 235 includes a wing of the second portion 240. The wing of the second portion 240 is coupled to a second arm 245. The second arm 245 may extend within at least a portion of a tank 250.

Referring to FIG. 2B, with continuing reference to FIG. 2A, in an embodiment, FIG. 2B illustrates a back side of the braking system 200 and includes several components of the braking system of FIG. 2A, which components are given the same reference numerals. The braking system 200 further includes a coupling device 255 that couples the lever 210 with the first arm 215. The braking system 200 may also include a pressure switch 260 and a pedal position sensor 265 coupled to a housing 270 of the braking system 200.

With continuing reference to FIGS. 2A and 2B, in some embodiments, the braking system 200 is the braking system 135 of FIG. 1. In some embodiments, the braking system 200 includes and/or is the master cylinder. In one or more embodiments, the braking system 200 is referred to as a bellcrank system. In some embodiments, a portion of the braking system 200, described herein, may be installed at a ninety-degree angle to fit in a vehicle with less space between the bulkhead and firewall and/or a vehicle with a cabover design such as a low-speed vehicle (LSV). In other embodiments, the interlocking bellcrank 220 allows for the master cylinder and/or a portion of the braking system 200 to be installed any configuration from 0 to 360 degrees.

In some embodiments, the brake pedal 205 is directly coupled to the lever 210.

In one or more embodiments, the lever 210 is coupled to the first arm 215 via the coupling device 255. In some embodiments, the coupling device 255 provides an axis of rotation or fulcrum for the lever 210. In some embodiments, the lever 210 includes a through hole and the first arm 215 is coupled via a bolt through the through hole. In some embodiments, the lever is coupled to the housing 270 via a bolt (representing the fulcrum of the lever 210) to move the lever 210 about. In some embodiments, the coupling device 255 may include a first bolt that extends transversely through a width of the lever 210, a second bolt that extends transversely through a width of the first arm 215, and a joint that extends from the first bolt to the second bolt such that the lever 210 is coupled to the first arm 215. In some embodiments, the coupling device 255 couples a first end portion of the lever 210 to a first end portion of the first arm 215.

In some embodiments, the first end portion of the first arm 215 extends over the first end portion of the lever 210 and a second, opposing end portion of the first arm 215 extends toward the brake pedal 205 and is coupled to the wing portion of the first portion 230. In some embodiments, the first arm 215 is composed of metal, plastic, or the like. In some embodiments, the second end portion of the first arm 215 is coupled to the wing portion of the first portion 230 via a bolt. In other embodiments, an alternative coupling device is used such as a clip, hook, or the like. In some embodiments, the first arm 215 is integrally formed and/or permanently coupled to the wing portion of the first portion 230.

In one or more embodiments, the interlocking bellcrank 220 includes the first portion 225 disposed over the second portion 235. In some embodiments, the interlocking bellcrank 220 includes a pin, rod, screw, or the like that extends down a central lumen or through-hole of the first portion 225 and the second portion 235. In some embodiments, the interlocking bellcrank 220 also includes a nut, washer, or the like to couple the pin, rod, screw, or the like to the housing 270. In some embodiments, the interlocking bellcrank 220 includes a pin, rod, screw, or the like that extends from a first side of the housing 270 through the first portion 225 and the second portion 235 to a second side of the housing 270. In some embodiments, the rod, pin, or screw is fastened and/or coupled to the housing 270. In some embodiments, the interlocking bellcrank 220 is sized to extend the entire height of the housing 270. In other embodiments, the interlocking bellcrank 220 does not extend the full height of the housing 270. In yet other embodiments, the first portion 225 and the second portion 235 do not extend the full height of the housing 270; however, the rod, pin, screw, or the like inserted into the first portion 225 and the second portion 235 extends at least the full height of the housing 270. In some embodiments, the interlocking bellcrank 220 includes a pin, rod, screw or the like and an axis of rotation about the pin, rod, screw, or the like.

In some embodiments, the first portion 225 is in direct contact with the second portion 235. In some embodiments, the first portion 225 has a first set of cutouts, keyshafts, or indentations that form a keyway, and the second portion 235 has a second set of cutouts, keyshafts, or indentations that form another keyway. In some embodiments, the keyways are the keyways described herein. In some embodiments, the second portion 235 interlocks with the first portion 225 using these keyways. In some embodiments, the first portion 225 is the same size (height, weight, and/or width) as the size of the second portion 235. In other embodiments, the first portion 225 differs in size from the size of the second portion 235. In some embodiments, a top surface of the first portion 225 is in contact with the housing 270. In one or more embodiments, a bottom surface of the first portion 225 is in contact with a top surface of the second portion 235. In some embodiments, a bottom surface of the second portion 235 is in contact with the housing 270. In one or more embodiments, the top surface of the first portion 225 opposes the bottom surface of the first portion 225. In one or more embodiments, the top surface of the first portion 225 opposes the bottom surface of the second portion 235. In some embodiments, the top surface of the second portion 235 opposes the bottom surface of the second portion 235. In some embodiments, the first portion 225 and the second portion 235 both have a through-hole. In some embodiments, the through-hole of the first portion 225 is aligned with the through-hole of the second portion 235.

In some embodiments, the wing of the first portion 230 is integrally formed into the first portion 225. In other embodiments, the wing of the first portion 230 is a separate component from the first portion 225. In some embodiments, the wing of the first portion 230 has a first edge. In some embodiments, the first edge is rounded. In some embodiments, the wing of the first portion 230 includes a through-hole near the first edge. In some embodiments, the first arm 215 is coupled to wing of the first portion 230 by a bolt, screw, or the like extending from the first arm 215 through the through-hole and secured via a nut. In other embodiments, other coupling means, such as a hook extending from the arm through the through-hole, are used to couple the first arm 215 to the wing of the first portion 230.

In some embodiments, the wing of the second portion 235 is integrally formed into the first portion 225. In other embodiments, the wing of the second portion 235 is a separate component from the first portion 225. In some embodiments, the wing of the second portion 235 has a first edge. In some embodiments, the first edge is rounded. In some embodiments, the wing of the second portion 235 includes a through-hole near the first edge. In some embodiments, the second arm 245 is coupled to wing of the second portion 235 by a bolt, screw, or the like extending from the second arm 245 through the through-hole and secured via a nut. In other embodiments, other coupling means, such as a hook extending from the arm through the through-hole, are used to couple the second arm 245 to the wing of the second portion 235. In other embodiments, the second arm 245 is permanently coupled to and/or integrally formed with the wing of the second portion 235.

In one or more embodiments, the second arm 245 is operationally coupled to the wing of the second portion 235 and a plunger (not shown) in the tank 250. The second arm 245, in some embodiments, is directly coupled to the plunger in the tank 250. The second arm 245 may be made of plastic, metal, or a similar material.

In some embodiments, the tank 250 is in communication with the second arm 245. The tank 250 contains brake fluid. In some embodiments, the tank 250 may include a sensor such as sensor 145 that indicates when there is a shortage of brake fluid. The tank 250, in some embodiments, may be a cylindrical tank as shown, but it also may be another shape. The tank 250 includes a plunger. The plunger may be a horizontally moving plunger to which the second arm 245 is coupled. In other embodiments, a vertically moving plunger is used. The tank 250 may be in communication with brake lines to distribute the brake fluid.

In one or more embodiments, the pressure switch 260 is used to sense when the brake pedal 205 is depressed, in order to turn on the brake lights (not shown). The pressure switch 260 is mounted to, or near, the braking system 200. In some embodiments, the pressure switch 260 may be located near the lever 210 or the first arm 215. The pressure switch 260 may be coupled to the bellcrank 220. In other embodiments, the pressure switch 260 is coupled to the brake pedal 205. In yet other embodiments, the pressure switch 260 is mounted to the housing 270. In some embodiments, the pressure switch 260 is a strain gauge.

In one or more embodiments, the pedal position sensor 265 is used to measure a threshold or range. The pedal position sensor 265 may help to optimize regenerative braking for a vehicle such as LSV 100. For example, the pedal position sensor 265 may provide data to an inverter such as the range of the brake pedal stroke. The pedal position sensor 265 may be located on the housing 270. The pedal position sensor 265 may be located near the end of the lever 210 that is opposite the brake pedal 205.

In one or more embodiments, the housing 270 encases the interlocking bellcrank 220 and at least a portion of first arm 215 and second arm 245. In some embodiments, the housing 270 encases four sides (a top, bottom, left, and right), such as shown in FIGS. 2A and 2B. In other embodiments, the housing 270 encases all sides. In yet another embodiment, the housing 270 encases all sides except the back side to leave room for movement of the first arm 215 and/or the lever 210. In some embodiments, the second arm 245 may stop when it hits a first side of the housing 270, and/or may extend past an opposing second side of the housing 270. In one or more embodiments, the housing 270 includes one or more stoppers to stop movement of the first arm 215 and/or the second arm 245. The stoppers may include a bolt or nail extending within a housing. The housing 270 may include a plurality of bolts to hold the housing 270 together. In some embodiments, the housing 270 may be a rectangular shape. The housing 270 may extend, in one or more embodiments, to include a housing of the tank 250. The housing 270, in some embodiments, may include a portion that couples to the tank 250. In one or more embodiments, the housing 270 fully encases the second arm 245

In operation, the brake pedal 205 is depressed by a foot of a driver of a vehicle (such as LSV 100). By depressing the brake pedal (applying a force), the lever 210 attached to the brake pedal 205 moves about the fulcrum of the lever 210 becoming substantially perpendicular to the housing 270. As the lever 210 moves backward toward a firewall (or front) of the vehicle, the first arm 215 which is coupled on a first side to the lever 210 moves forward (away from the firewall of the vehicle). The first arm 215 is coupled on a second side to a wing of the first portion 230 of the interlocking bellcrank 220. Therefore, as the first side of the first arm 215 moves forward, the second side of the first arm 215 rotates the wing of the first portion 230 clockwise about an axis of rotation. The first portion 225 of the interlocking bellcrank 220 is in direct contact with the second portion 235; therefore, as the first portion 225 is rotated about a fixed axis, the second portion 235 is also rotated. The second portion 235 includes a wing of the second portion 240 to which the second arm 245 is coupled. Therefore, as the wing of the second portion 240 rotates along the axis of rotation, the coupled second arm 245 moves transversely. The second arm 245 is operationally coupled to a horizontally moving plunger in the tank 250 which pressurized brake fluid in the tank 250. Therefore, the braking system 200 transfers output of a linear motion around a fixed axis via a rotational motion then to a transverse motion in order to pressurize brake fluid.

In some embodiments, the second portion 235 is rotated clockwise. In other embodiments, the second portion 235 is rotated counterclockwise. In one or more embodiments, the wing of the first portion 230 rotates counter-clockwise about an axis of rotation and/or the wing of the second portion 240 rotates counter-clockwise about an axis of rotation. In some embodiments, a vertical axis is defined by a through-hole that extends down a center of the first portion 225 and a center of the second portion 235. In some embodiments, the vertical axis is the axis of rotation. In other embodiments, the axis of rotation is along the longitudinal axis or lateral axis. In some embodiments, the second arm 245 moves transversely left to right. In other embodiments, the second arm 245 moves transversely right to left. In some embodiments, the second arm 245 moves in the same direction as wing of the second portion 240. In some embodiments, the interlocking bellcrank 220 may apportion any transverse motion, such as 90 degrees to the right. In other embodiments, the interlocking bellcrank 220 may apportion any transverse motion such as 90 degrees to the left. In other embodiments, other angles (between 0 and 360 degrees) are used to change activation.

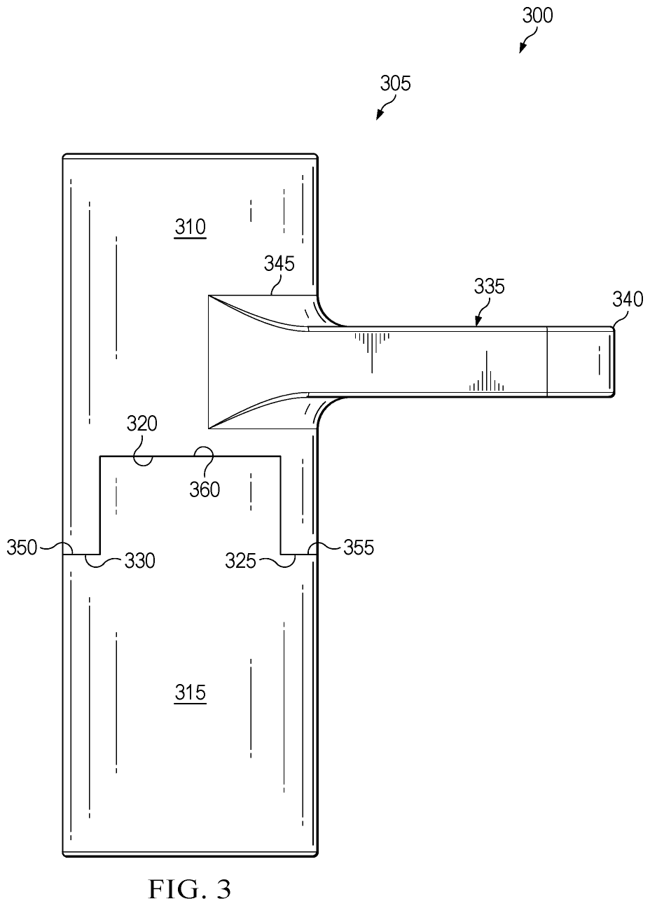

Referring to FIG. 3, in an embodiment, FIG. 3 illustrates a front side of an interlocking bellcrank, the front side of the interlocking bellcrank is generally referred to by the reference numeral 300 and the interlocking bellcrank is generally referred to by reference numeral 305. The interlocking bellcrank 305 includes a first portion 310 and a second portion 315, disposed directly beneath the first portion 310. The first portion 310 includes a first cut-out portion 320, a first extended portion 325, and a second extended portion 330. The first portion 310 also includes a wing 335 defined between a first edge 340 and a second edge 345. The second portion 315 includes a first cut-out portion 350, a second cut-out portion 355, and a first extended portion 360.

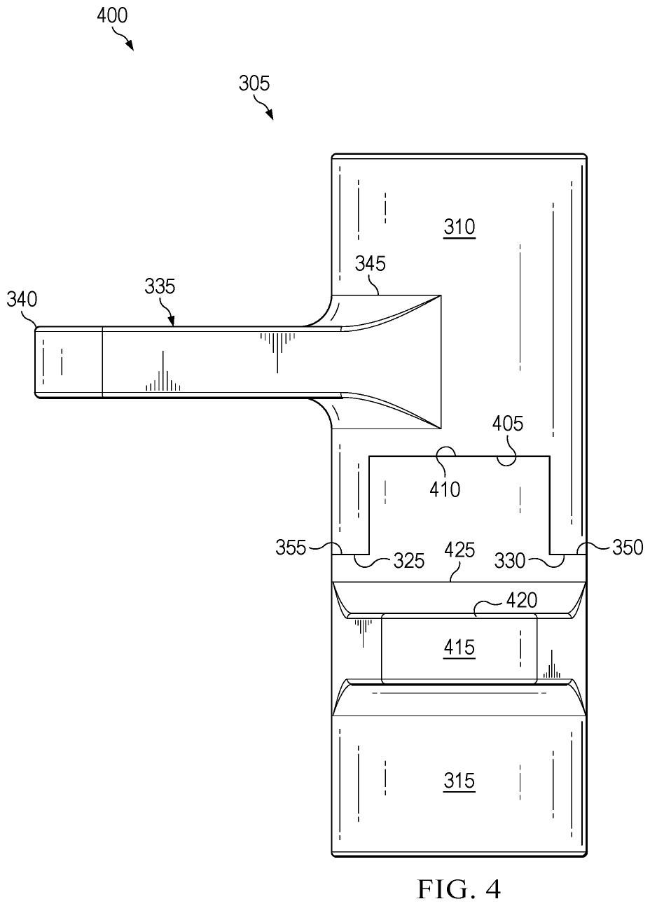

Referring to FIG. 4, in an embodiment, FIG. 4 illustrates a back view of the interlocking bellcrank 305, generally referred to by the reference numeral 400 and includes several components of FIG. 3, which components are given the same reference numerals. The interlocking bellcrank 305 includes the first portion 310 and the second portion 315, disposed directly beneath the first portion 310. The first portion 310 includes a second cut-out portion 405, the first extended portion 325, and the second extended portion 330. The first portion 310 also includes the wing 335 defined between the first edge 340 and the second edge 345. The second portion 315 includes the first cut-out portion 350, the second cut-out portion 355, and a second extended portion 410. The second portion 315 also includes a wing 415 defined between a first edge 420 and a second edge 425.

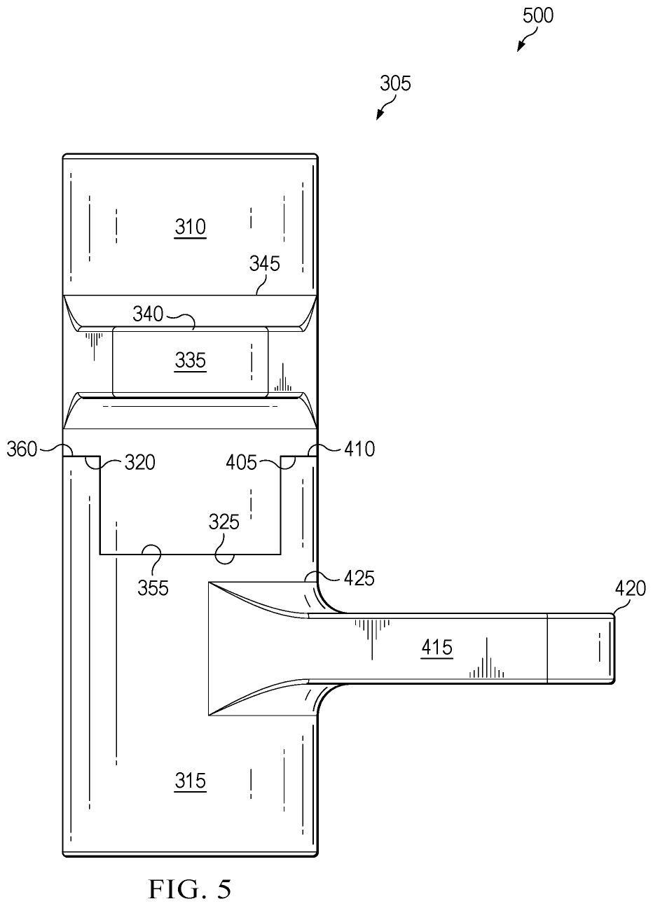

Referring to FIG. 5, in an embodiment, FIG. 5 illustrates a right view of the interlocking bellcrank 305, generally referred to by the reference numeral 500 and includes several components of FIGS. 3 and 4, which components are given the same reference numerals. The interlocking bellcrank 305 includes the first portion 310 and the second portion 315, disposed directly beneath the first portion 310. The first portion 310 includes the first cut-out portion 320, the second cut-out portion 405, and the first extended portion 325. The first portion 310 also includes the wing 335 defined between the first edge 340 and the second edge 345. The second portion 315 includes the second cut-out portion 355, the first extended portion 360, and the second extended portion 410. The second portion 315 also includes the wing 415 defined between the first edge 420 and the second edge 425.

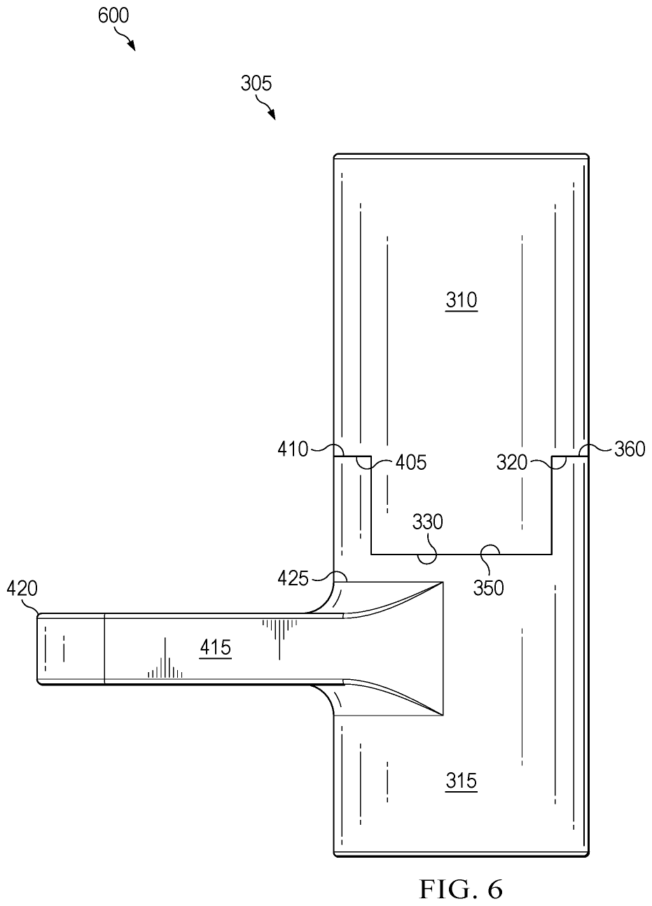

Referring to FIG. 6, in an embodiment, FIG. 6 illustrates a left view of the interlocking bellcrank 305, generally referred to by the reference numeral 600 and includes several components of FIGS. 3-5, which components are given the same reference numerals. The interlocking bellcrank 305 includes the first portion 310 and the second portion 315, disposed directly beneath the first portion 310. The first portion 310 includes the first cut-out portion 320, the second cut-out portion 405, and the second extended portion 330. The second portion 315 includes the first cut-out portion 350, the first extended portion 360, and the second extended portion 410. The second portion 315 also includes the wing 415 defined between the first edge 420 and the second edge 425.

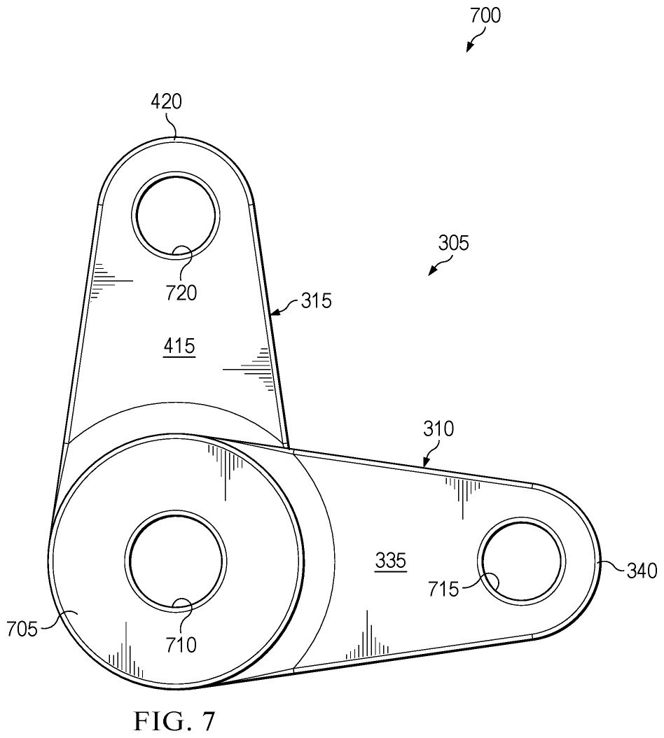

Referring to FIG. 7, in an embodiment, FIG. 7 illustrates a top view of the interlocking bellcrank 305, generally referred to by the reference numeral 700 and includes several components of FIGS. 3-6, which components are given the same reference numerals. The interlocking bellcrank 305 includes the first portion 310 and the second portion 315, disposed directly beneath the first portion 310. The first portion 310 includes the wing 335. The wing 335 is defined in part by the first edge 340. The second portion 315 includes the wing 415 defined in part by the first edge 420. The first portion 310 includes a top surface 705. The top surface 705 is a circular surface. The top surface 705 includes a through-hole 710 extending down the length of the first portion 310. The wing 335 of the first portion 310 includes a through-hole 715 near the first edge 340. The wing 415 of the second portion 315 includes a through-hole 720 near the first edge 420.

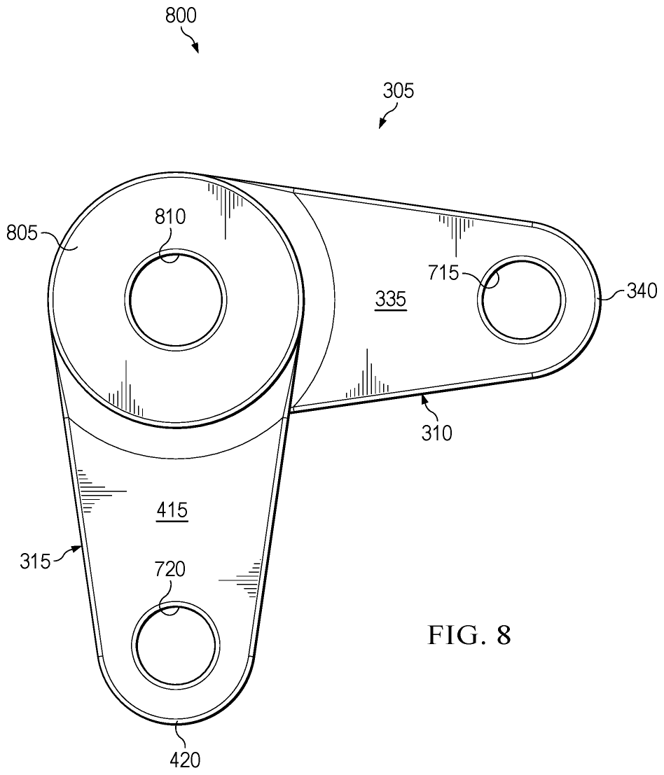

Referring to FIG. 8, in an embodiment, FIG. 8 illustrates a bottom view of the interlocking bellcrank 305, generally referred to by the reference numeral 800 and includes several components of FIGS. 3-7, which components are given the same reference numerals. The interlocking bellcrank 305 includes the first portion 310 and the second portion 315. The first portion 310 includes the wing 335. The wing 335 is defined in part by the first edge 340. The second portion 315 includes the wing 415 defined in part by the first edge 420. The second portion 315 includes a bottom surface 805. The bottom surface 805 is a circular surface. The bottom surface 805 includes a through-hole 810 extending down the length of the second portion 315. The wing 335 of the first portion 310 includes a through-hole 715 near the first edge 340. The wing 415 of the second portion 315 includes a through-hole 720 near the first edge 420.

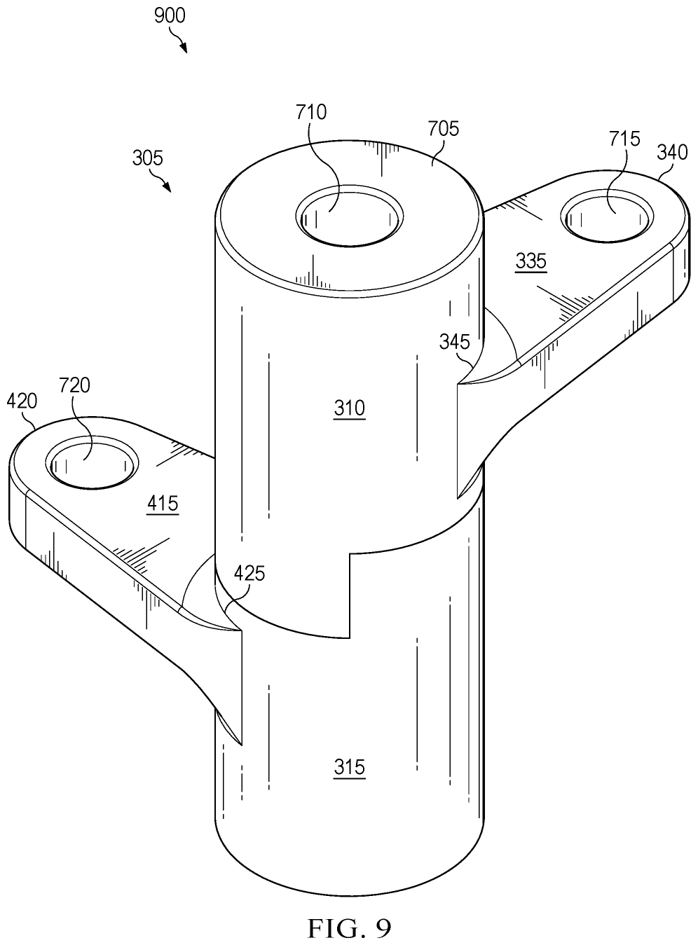

Referring to FIG. 9, in an embodiment, FIG. 9 illustrates a top perspective view of the interlocking bellcrank 305, generally referred to by the reference numeral 900 and includes several components of FIGS. 3-8, which components are given the same reference numerals. The interlocking bellcrank 305 includes the first portion 310 and the second portion 315, disposed directly beneath the first portion 310. The first portion 310 includes the wing 335. The wing 335 is defined in part by the first edge 340 and the second edge 345. The second portion 315 includes the wing 415 defined in part by the first edge 420 and the second edge 425. The first portion 310 includes the top surface 705. The top surface 705 includes the through-hole 710 extending down the length of the first portion 310. The wing 335 of the first portion 310 includes the through-hole 715 near the first edge 340. The wing 415 of the second portion 315 includes the through-hole 720 near the first edge 420.

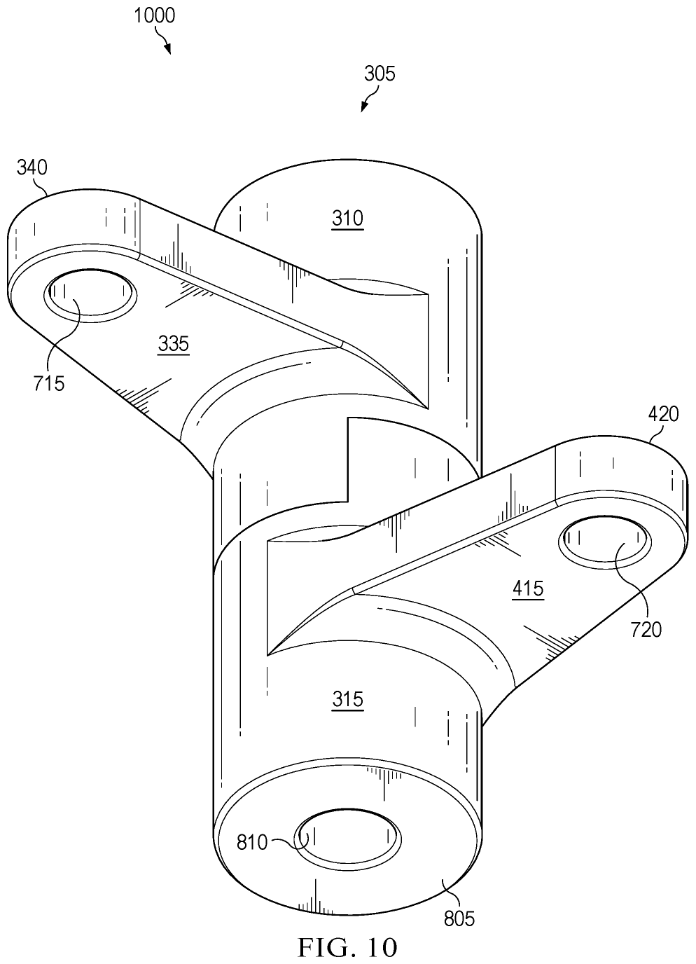

Referring to FIG. 10, in an embodiment, FIG. 10 illustrates a bottom perspective view of the interlocking bellcrank 305, generally referred to by the reference numeral 1000 and includes several components of FIGS. 3-9, which components are given the same reference numerals. The interlocking bellcrank 305 includes the first portion 310 and the second portion 315. The first portion 310 includes the wing 335. The wing 335 is defined in part by the first edge 340. The second portion 315 includes the wing 415 defined in part by the first edge 420. The second portion 315 includes the bottom surface 805. The bottom surface 805 includes the through-hole 810 extending down the length of the second portion 315 through the length of the first portion 310. The wing 335 of the first portion 310 includes the through-hole 715 near the first edge 340. The wing 415 of the second portion 315 includes the through-hole 720 near the first edge 420.

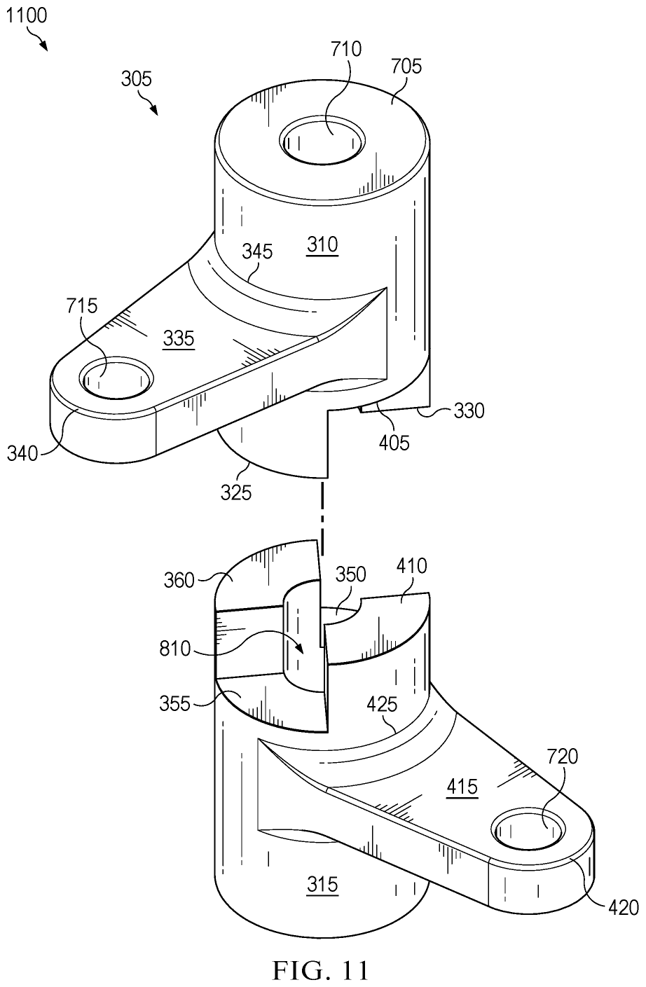

Referring to FIG. 11, in an embodiment, FIG. 11 illustrates a top perspective, exploded view of the interlocking bellcrank 305, generally referred to by the reference numeral 1100 and includes several components of FIGS. 3-10, which components are given the same reference numerals. The interlocking bellcrank 305 includes the first portion 310 and the second portion 315, disposed directly beneath the first portion 310. The first portion 310 includes the first extended portion 325, the second cut-out portion 405, and the second extended portion 330. The first portion 310 includes the wing 335. The wing 335 is defined in part by the first edge 340 and the second edge 345. The second portion 315 includes the first cut-out portion 350, the second cut-out portion 355, the first extended portion 360, and the second extended portion 410. The second portion 315 includes the wing 415 defined in part by the first edge 420 and the second edge 425. The first portion 310 includes the top surface 705. The top surface 705 includes the through-hole 710 extending down the length of the first portion 310. The second portion 315 includes the through-hole 810 extending down the length of the second portion 315. The wing 335 of the first portion 310 includes the through-hole 715 near the first edge 340. The wing 415 of the second portion 315 includes the through-hole 720 near the first edge 420.

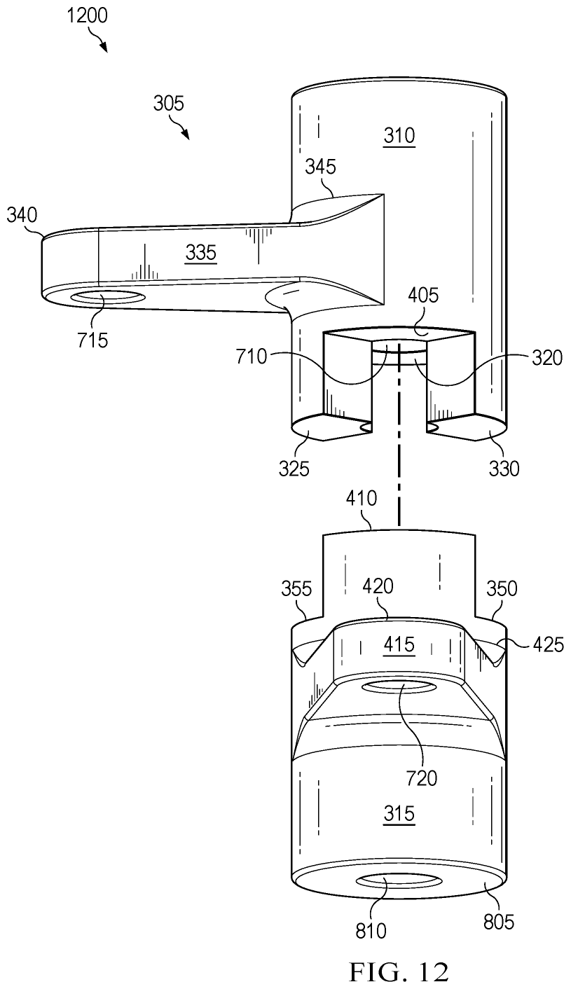

Referring to FIG. 12, in an embodiment, FIG. 12 illustrates a bottom perspective, exploded view of the interlocking bellcrank 305, generally referred to by the reference numeral 1200 and includes several components of FIGS. 3-11, which components are given the same reference numerals. The interlocking bellcrank 305 includes the first portion 310 and the second portion 315. The first portion 310 includes the first extended portion 325, the second extended portion 330, the first cut-out portion 320, and the second cut-out portion 405. The first portion 310 includes the wing 335. The wing 335 is defined in part by the first edge 340. The second portion 315 includes the first cut-out portion 350, the second cut-out portion 355, and the second extended portion 410. The second portion 315 includes the wing 415 defined in part by the first edge 420. The second portion 315 includes the bottom surface 805. The bottom surface 805 includes the through-hole 810 extending down the length of the second portion 315 through the length of the first portion 310. The wing 335 of the first portion 310 includes the through-hole 715 near the first edge 340. The wing 415 of the second portion 315 includes the through-hole 720 near the first edge 420.

In some embodiments, the first portion 310 includes a plurality of extended portions. In some embodiments, the first portion 310 includes only one extended portion. In some embodiments, the first portion 310 includes greater than two extended portions. In some embodiments, the first portion 310 includes a plurality of cut-out portions. In some embodiments, the first portion 310 includes only one cut-out portion. In some embodiments, the first portion 310 has a number greater than 2 for number of cut-outs. In some embodiments, the size and shape of the plurality of cut-outs and/or the plurality of extended portions of the first portion 310 differs. In some embodiments, the plurality of cut-out portions are referred to as a plurality of indentations or keyseats. In some embodiments, the plurality of extended portions and the plurality of cut-outs are referred to as keyways. In some embodiments, a length of the plurality of extended portions extends past a length of the plurality of cut-outs.

In some embodiments, the second portion 315 includes a plurality of extended portions. In some embodiments, the second portion 315 includes only one extended portion. In some embodiments, the second portion 315 includes greater than two extended portions. In some embodiments, the second portion 315 includes a plurality of cut-out portions. In some embodiments, the second portion 315 includes only one cut-out portion. In some embodiments, the second portion 315 has a number greater than 2 for number of cut-outs. In some embodiments, the size and shape of the plurality of cut-outs and/or the plurality of extended portions of the second portion 315. In some embodiments, the plurality of cut-outs are referred to as a plurality of indentations or keyseats. In some embodiments, the plurality of extended portions and the plurality of cut-outs are referred to as keyways. In some embodiments, a length of the plurality of extended portions extends past a length of the plurality of cut-outs. In some embodiments, the plurality of extended portions of the second portion 315 interlock with the cut-out portions of the first portion 310, and the plurality of cut-out portions of the second portion 315 interlock with the extended portions of the first portion 310.

In some embodiments, the first extended portion 325 is disposed within the second cut-out portion 355. In other embodiments, the first extended portion 325 is disposed instead within the first cut-out portion 350. In some embodiments, the second extended portion 330 is disposed within the first cut-out portion 350. In other embodiments, the second extended portion 330 is disposed within the second cut-out portion 355. In some embodiments, the first extended portion 325 is separated by 180 degrees from the second extended portion 330. In one or more embodiments, the first extended portion 325 is the same size as the second extended portion 330. In some embodiments, the first extended portion 325 is a different size as the second extended portion 330. In one or more embodiments, the first extended portion 325 is directly across from the second extended portion 330.

In some embodiments, the first cut-out portion 320 is separated by 180 degrees from the second cut-out portion 405. In some embodiments, the first cut-out portion 320 is separated by less than 180 degrees from the second cut-out portion 405. In one or more embodiments, the first cut-out portion 320 is the same size as the second cut-out portion 405. In some embodiments, the first cut-out portion 320 is a different size than the size of the second cut-out portion 405. In one or more embodiments, the first cut-out portion 320 is directly across from the second cut-out portion 405.

In some embodiments, the first extended portion 360 is disposed within the first cut-out portion 320. In other embodiments, the first extended portion 360 is disposed instead within the second cut-out portion 405. In some embodiments, the second extended portion 410 is disposed within the first cut-out portion 320. In other embodiments, the second extended portion 410 is disposed within the second cut-out portion 405. In some embodiments, the first extended portion 360 is separated by 180 degrees from the second extended portion 410. In one or more embodiments, the first extended portion 360 is the same size as the second extended portion 410. In some embodiments, the first extended portion 360 is a different size as the second extended portion 410. In one or more embodiments, the first extended portion 360 is directly across from the second extended portion 410.

In some embodiments, the first cut-out portion 350 is separated by 180 degrees from the second cut-out portion 355. In some embodiments, the first cut-out portion 350 is separated by less than 180 degrees from the second cut-out portion 355. In one or more embodiments, the first cut-out portion 350 is the same size as the second cut-out portion 355. In some embodiments, the first cut-out portion 350 is a different size than the size of the second cut-out portion 355. In one or more embodiments, the first cut-out portion 350 is directly across from the second cut-out portion 355.

The wing 335, in one or more embodiments, has a sharp edge 340. In some embodiments, the wing 355 is integrally formed with the first portion 310. In other embodiments, the wing 335 is a separate component that is coupled to the first portion 310.

The wing 415, in one or more embodiments, has a sharp edge 420. In some embodiments, the wing 415 is integrally formed with the second portion 315. In other embodiments, the wing 415 is a separate component that is coupled to the second portion 315.

In some embodiments, the top surface 705 mirrors the bottom surface 805. In some embodiments, the top surface 705 differs in shape, smoothness, or size from the bottom surface 805. In some embodiments, the top surface 705 and/or the bottom surface is rectangular.

In some embodiments, the through-hole 710 is aligned with the through-hole 810 such that a pin, screw, rod, or the like may pass through the entire length of the interlocking bellcrank 305. In some embodiments, the through-hole 710 is the same as the through-hole 810. In some embodiments, the through-hole 710 is the same size as the through-hole 810. In some embodiments, the through-hole 715 is the same size as the through-hole 720. In other embodiments, the through-hole 715 and/or the through-hole 720 is omitted. In some embodiments, a screw, pin, rod, or the like may be inserted into the through-hole 715 and/or 720 to couple the wing 335 and the wing 415, respectively, to an arm, lever, or the like. In some embodiments, a clamp or other similar device is used to couple the wing 335 and/or the wing 415 to an arm, lever, or the like.

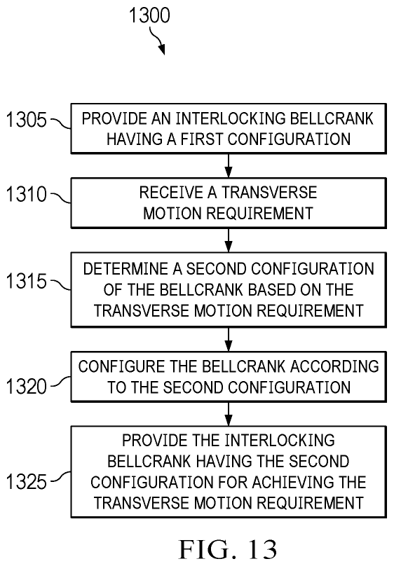

With reference to FIG. 13, a method 1300 for changing the direction of actuation of a bellcrank system by transforming the bellcrank system from a first configuration to a second configuration, according to one or more embodiments. The method 1300 illustrates the advantages of the invention by providing various configurations depending on the required transverse motion. Method 1300 is illustrated as a set of operations or blocks 1305 through 1325. Not all of the illustrated blocks 1305 through 1325 may be performed in all embodiments of method 1300. One or more blocks that are not expressly illustrated in FIG. 13 may be included before, after, in between, or as part of the blocks 1305 through 1325. In one or more embodiments, the blocks in method 1300 are performed for a vehicle such as vehicle 100, or any of the other embodiments described herein.

The method 1300 includes: providing an interlocking bellcrank having a first configuration at a block 1305; receiving a transverse motion requirement at a block 1310; determining a second configuration of the bellcrank based on the transverse motion requirement at a block 1315; configuring the bellcrank according to the second configuration at a block 1320; and providing the bellcrank having the second configuration for achieving the transverse motion requirement at a block 1325.

In some embodiments, at the block 1305, the interlocking bellcrank has a first transverse motion requirement. In some embodiments, the interlocking bellcrank has a first angle of actuation or first direction of actuation (such as a right-hand push). In some embodiments, the interlocking bellcrank may be any bellcrank device described herein.

In some embodiments, at the block 1310, a user determines that a different transverse motion is needed. In some embodiments, at the block 1310, a transverse motion requirement of the first configuration is made and compared to the received transverse motion requirement. If different, then a second configuration of the bellcrank is needed. In one or more embodiments, receiving a transverse motion requirement is receiving a change in the angle of actuation and/or the direction of actuation.

In one or more embodiments, the block 1320 includes rotating a first portion of the bellcrank and inserting the rotated first portion into a second portion. In other embodiments, at the block 1320, the second portion is rotated and inserted into the non-rotated first portion. In some embodiments, the block 1320 includes unfastening a first arm attached to a first wing of a first portion of an interlocking bellcrank device and a second arm attached to a first wing of a second portion of the interlocking bellcrank; removing a pin that extends between the first portion and the second portion of the interlocking bellcrank; separating the first portion from the second portion; rotating the first portion 180 degrees so that a keyway of the first portion is over a different portion of a keyway of the second portion; sliding the rotated keyway of the first portion into the keyway of the second portion to interlock the bellcrank; and/or inserting a pin and refastening the first and second arms to the first wing of the first portion and the first wing of the second portion, respectively. In some embodiments, the block 1320 includes unfastening the first arm and unfastening the second arm. In some embodiments, the second arm is unfastened prior to unfastening the first arm. In some embodiments, the first arm and/or the second arm is unfastened by removing a nut, washer, a hook, and/or bolt that extends from the first arm and/or the second arm through a through-hole of the first wing of the first portion and the first wing of the second portion, respectively. In other embodiments, the first arm and/or second arm is clamped on to the first wing of the first portion and/or the first wing of the second portion, respectively. In some embodiments, the pin is instead a rod, nail, or screw. In one or more embodiments, at the block 1320, the second portion is separated from the first portion. In other embodiments, at the block 1320, the first portion is pulled apart from the second portion. In some embodiments, at the block 1320, the second portion is instead rotated 180 degrees to change the orientation. In some embodiments, the first portion is instead rotated less than 180 degrees such as 90 degrees.

In one or more embodiments, at the block 1320 or the block 1325, the rotated keyway of the second portion is inserted into the keyway of the first portion. In some embodiments, the rotated keyway of the first portion is inserted into a rotated keyway of the second portion.

In some embodiments, at the block 1325 the bellcrank is interlocked and ready to perform actuation. In some embodiments, at the block 1325, the interlocking bellcrank in the second configuration performs a right-hand push, whereas in the first configuration, the interlocking bellcrank performed a left-handed push. In other embodiments, at the block 1325, the interlocking bellcrank in the second configuration performs a left-hand push, whereas in the first configuration, the interlocking bellcrank performed a right-handed push. In some embodiments, the angle of the push differs between the first configuration and the second configuration. In other embodiments, the direction of the push or actuation differs between the first configuration and the second configuration.

In some embodiments, at the block 1325, the interlocking bellcrank may have a second transverse motion requirement, different from the first. In some embodiments, the transverse motion requirement is the transverse motion requirement of block 1310. In some embodiments, the interlocking bellcrank has a second angle of actuation or second direction of actuation (such as a left-hand push) that is different from the first angle of actuation and/or second direction of actuation. In some embodiments, after block 1325, the first and second arms are fastened prior to inserting the pin. In some embodiments, the second arm is fastened to the first wing of the second portion first. In other embodiments, the first arm is fastened to the first wing of the first portion first. In yet another embodiment, the pin is inserted through a through-hole of the first portion and a through-hole of the second portion. In some embodiments, the pin is additionally secured to a housing via a nut. In some embodiments, the first arm and/or the second arm is fastened to the first wing of the first portion and to the first wing of the second portion, respectively, using a bolt, screw, hook, clamp, nut, and the like.

In one or more embodiments, additional configurations are provided based on the received transverse motion requirement.

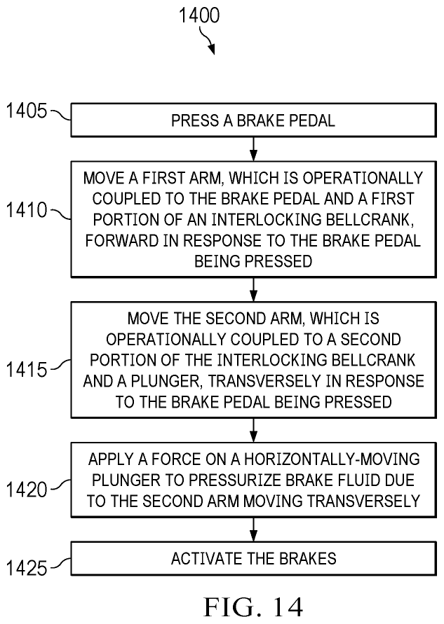

With reference to FIG. 14, a method 1400 for activating brakes in a vehicle, according to one or more embodiments. Method 1400 is illustrated as a set of operations or blocks 1405 through 1425. Not all of the illustrated blocks 1405 through 1425 may be performed in all embodiments of method 1400. One or more blocks that are not expressly illustrated in FIG. 14 may be included before, after, in between, or as part of the blocks 1400 through 1405. In some embodiments, one or more of the blocks 1405 through 1425 may be implemented, at least in part, by a controller (such as controller 120) which may include a processor, such as processor, in the form of executable code stored on non-transitory, tangible, machine-readable media that when run by one or more processors may cause the one or more processors to perform one or more of the processes. In one or more embodiments, the blocks in method 1400 are performed within a vehicle, such as LSV 100, or any of the other embodiments described herein.

The method 1400 includes: pressing a brake pedal at a block 1405, moving a first arm, which is operationally coupled to the brake pedal and a first portion of an interlocking bellcrank, forward in response to the brake pedal being pressed at block 1410; moving the second arm, which is operationally coupled to a second portion of the interlocking bellcrank and a plunger, transversely in response to the brake pedal being pressed at a block 1415; applying a force on a horizontally-moving plunger to pressurize brake fluid due to the second arm moving transversely at a block 1420; and activating the brakes at a block 1425.

In some embodiments, the method 1400 provides for transferring an output of a linear motion around a fixed axis via a rotational motion then to a transverse motion to pressurize brake fluid in a master cylinder, which is beneficial in vehicles such as LSV 100 that has a cabover design and/or limited space between a bulkhead and a firewall.

In some embodiments, a driver of vehicle 100 presses the brake pedal with his/her foot at the block 1405. In one or more embodiments, the brake pedal is pressed in a first direction.

In one or more embodiments, the block 1410 occurs simultaneously to the block 1405. In one or more embodiments, the first arm moves in a second direction, opposing the first direction in response to the brake pedal being pressed at the block 1410. In some embodiments, the first arm is coupled to a lever that is coupled to the brake pedal as described herein.

In some embodiments, an additional block is added after the block 1410 that rotates the first portion about a vertical axis of the interlocking bellcrank in response to the brake pedal being pressed. In some embodiments, an additional block is added that occurs simultaneously to the block 1410 that rotates the first portion of the interlocking bellcrank in response to the first arm moving forward. In some embodiments, only a partial rotation is completed.

In one or more embodiments, the second arm moves transversely right to left at the block 1415. In other embodiments, the second arm moves left to right, transversely, at the block 1415. In some embodiments, the block 1415 occurs simultaneously to the block 1405 and/or the block 1410.

In some embodiments, the block 1420 occurs simultaneously to the block 1405, block 1410, and/or block 1415. In some embodiments, the plunger moves along the same direction as the second arm at the block 1420. In some embodiments, the plunger is located within a brake fluid tank as described herein. In some embodiments, another arm couples the plunger to the second arm and the plunger is instead a vertically moving plunger. The vertical extending plunger moves up to pressurize the fluid tank, in some embodiments.

In some embodiments, an additional block is added after the block 1415 or block 1420 that moves the second portion about a vertical axis of the interlocking bellcrank in response to the brake pedal being pressed. In some embodiments, an additional block is added that occurs prior to and/or simultaneously to the block 1415 that moves the second portion of the interlocking bellcrank which in response moves the second arm transversely.

In some embodiments, activating the brakes 1425 includes moving brake fluid through the brake lines. In other embodiments, the brakes are implemented to slow rotation of one or more wheels (such as wheels 140).

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In several example embodiments, while different blocks, processes, and procedures are described as appearing as distinct acts, one or more of the blocks, one or more of the processes, and/or one or more of the procedures may also be performed in different orders, simultaneously, and/or sequentially. In several example embodiments, the blocks, processes and/or procedures may be merged into one or more blocks, processes, and/or procedures.

In several example embodiments, one or more of the operational blocks in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

The phrase “at least one of A and B” should be understood to mean “A; B; or both A and B.” The phrase “one or more of the following: A, B, and C” should be understood to mean “A; B; C; A and B; B and C; A and C; or all three of A, B, and C.” The phrase “one or more of A, B, and C” should be understood to mean “A; B; C; A and B; B and C; A and C; or all three of A, B, and C.”

Although several example embodiments have been described in detail above, the embodiments described are examples only and are not limiting, and those skilled in the art will readily appreciate that many other modifications, changes, and/or substitutions are possible in the example embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A method, comprising:
providing an interlocking bellcrank in a first configuration;
receiving a transverse motion requirement;
determining a second configuration of the bellcrank based on the transverse motion requirement;
configuring the bellcrank according to the second configuration;
and
providing the interlocking bellcrank in the second configuration.

2. The method of claim 1,
wherein providing the interlocking bellcrank in the second configuration achieves the transverse motion requirement.

3. The method of claim 1, further comprising:
wherein receiving the transverse motion requirement comprises receiving a desired direction of actuation.

4. The method of claim 1,
wherein receiving the transverse motion requirement comprises receiving a desired direction of actuation.

5. The method of claim 1,
wherein the interlocking bellcrank in the first configuration achieves another transverse motion requirement.

6. The method of claim 5, further comprising:
wherein the another transverse motion requirement is opposite to the transverse motion requirement.

7. The method of claim 1, wherein receiving the transverse motion requirement comprises a user determining the transverse motion requirement.

8. The method of claim 1, wherein configuring the bellcrank according to a second configuration comprises:
removing a pin that extends from a first portion of the bellcrank through a second portion of the bellcrank, wherein the second portion is disposed directly beneath the first portion; and
pulling the first portion of the bellcrank from the second portion of the bellcrank.

9. The method of claim 8, wherein configuring the bellcrank according to a second configuration further comprises:
rotating the first portion of the bellcrank 180 degrees; and
inserting the first portion into the second portion.

10. The method of claim 8,
wherein configuring the bellcrank according to a second configuration further comprises:
rotating the second portion of the bellcrank 180 degrees; and
inserting the second portion into the first portion.

11. The method of claim 8, wherein configuring the bellcrank according to a second configuration further comprises:
de-coupling a first arm coupled to the first portion of the bellcrank; and
de-coupling a second arm coupled to the second portion of the bellcrank.

12. A bellcrank system, comprising:
a bellcrank comprising:
a first portion comprising a first top surface and a first bottom surface;
wherein the first bottom surface opposes the first top surface;
wherein the first bottom surface comprises a first set of indentations and a first set of extended portions;
wherein the first set of indentations and the first set of extended portions are disposed along a circumference of the first bottom surface; and
a second portion comprising a second top surface and a second bottom surface;
wherein the second bottom surface opposes the second top surface;
wherein the second bottom surface comprises a second set of indentations and a second set of extended portions;
wherein the second portion is disposed directly below the first portion such that:
the first set of indentations is configured to interlock with the second set of extended portions;
the second set of indentations is configured to interlock with the first set of extended portions; and
the first bottom surface is in direct contact with the second top surface; and
wherein the bellcrank comprises at least a first configuration and a second configuration.

13. The bellcrank system of claim 12,
wherein the first portion further comprises a first wing;
wherein the second portion further comprises a second wing;
wherein the first wing is disposed between the first top surface and the first bottom surface;
wherein the first wing extends laterally past the first top surface and the first bottom surface;
wherein the second wing is disposed between the second top surface and the second bottom surface; and
wherein the second wing extends laterally past the second top surface and the second bottom surface.

14. The bellcrank system of claim 13, further comprising:
a first arm coupled to the first wing; and
a second arm coupled to the second wing,
wherein, in the first configuration, the first arm is configured to rotate the first wing from a first position to a differing, second position; and
wherein, in the first configuration, the second wing is configured to simultaneously move the second arm transversely from a third position to a differing, fourth position.

15. The bellcrank system of claim 14,
wherein, in the second configuration, the first arm is configured to rotate the first wing from the second position to the first position; and
wherein, in the second configuration, the second wing is configured to simultaneously move the second arm transversely from the fourth position to the third position.

16. The bellcrank system of claim 12,
wherein the first set of indentations comprises at least a first indentation and a second indentation;
wherein the first set of extended portions comprises at least a first extended portion and a second extended portion;
wherein the second set of indentations comprises at least a third indentation and a fourth indentation; and
wherein the second set of extended portions comprises at least a third extended portion and a fourth extended portion.

17. The bellcrank system of claim 16,
wherein, in the first configuration, the first extended portion is disposed within the third indentation;
wherein, in the first configuration, the second extended portion is disposed within the fourth indentation;
wherein, in the first configuration, the third extended portion is disposed within the first indentation; and
wherein, in the first configuration, the fourth extended portion is disposed within the second indentation.

18. The bellcrank system of claim 16,
wherein, in the second configuration, the first extended portion is disposed within the fourth indentation;
wherein, in the second configuration, the second extended portion is disposed within the third indentation;
wherein, in the second configuration, the third extended portion is disposed within the second indentation; and
wherein, in the second configuration, the fourth extended portion is disposed within the first indentation.

19. The bellcrank system of claim 12, wherein, in the first configuration, the bellcrank is configured to actuate a left-hand push.

20. The bellcrank system of claim 12, wherein, in the second configuration, the bellcrank is configured to actuate a right-hand push.
